(19) United States
(12) Patent Application Publication
(10) Pub. No.: US 2012/0003993 A1
(43) Pub. Date: Jan. 5, 2012

(54) DISTRIBUTION SYSTEM FOR DATA ITEMS

(75) Inventors: Ville V LEINO, Turku (FI); Sami S. Leino, Turku (FI)

(73) Assignee: SPINLET OY, Espoo (FI)

(21) Appl. No.: 13/228,106

(22) Filed: Sep. 8, 2011

Related U.S. Application Data
(63) Continuation-in-part of application No. 11/705,153, filed on Feb. 12, 2007.

(51) Int. Cl. H04W 64/00

(52) U.S. Cl. 455/456.1

(57) ABSTRACT

Distribution system for data items where information on amounts of topics may be used to scope further actions on the information. Data items are created topically in various locations, provided with position-based annotation and made publicly available. Search on desired data items is scoped using views that show the amount of available data items for one or more sub-areas of a geographical area.

### RELATED APPLICATIONS

This application is a continuation-in-part application of U.S. patent application Ser. No. 11/705,153 filed on Feb. 12, 2007.

### FIELD OF THE INVENTION

The present invention relates to information techniques and especially to provision and distribution of information.

### BACKGROUND OF THE INVENTION

Conventionally people have been acquiring knowledge on various topics and their points of interest through established channels that feed information in a defined way in a defined time. It has been easy to turn to a particular page of a particular newspaper to find the news on a train crash the day before, or to watch particular news broadcast to hear the latest update on the coup in the planned vacation resort. In return, it has been accepted that between the occurrences and the time the information on the occurrence becomes available is a delay, and that the choice of subjects, as well as the extent and scope of their coverage follows a defined pattern characteristic for the policy adopted for the channel. Furthermore, the amount of reporters is limited so many subjects are missed.

As a result of increased use of Internet, and other advanced communication mechanisms, the forms of providing and distributing information has recently changed. There are Internet sites where people chat on any chosen topic and bring in news and views. Succulent stories circulate quickly in the Internet and sites comprising content on such story may very quickly be visited by a mass of users. There are even sites where individual users may post video clips on any subject. Through such site postings information on any subject may become available with minimal delay. Furthermore, each of the posted contents represents an editorial view of the person who created the content and thus by viewing several contents and representations on one occurrence, the authenticity of the information, and thereby the accuracy of the news is improved. Additionally, due to the large number of virtual reporters, the amount of subjects that may be continuously covered is huge. However, material that is created practically randomly by a plurality of users and is made available in various different sites and made accessible in various different forms are extremely difficult to search systematically. The search engines are powerful but rely only in use of search terms. Since the creators typically use different terms in naming their content, finding a desired piece of information on a particular topic is yet a matter of good luck more than a result of systematic operations.

### SUMMARY OF THE INVENTION

An aspect of the present invention is to acquire information on amounts of topics may be acquired and use the acquired information to scope further actions for searching and retrieving the information.

According to an aspect of the invention data items may be created topically in various locations, the data items may be provided with position-based annotation and the data items may be made publicly available. Search on desired data items may then be scoped using data item views that show the amount of available data items for one or more sub-areas of a geographical area corresponding to the view.

An aspect of the invention is a method, comprising:

initiating a background monitoring process in a mobile user terminal of a communication system;

monitoring, by said background monitoring process, application programs or at least one sensor in the mobile user terminal;

recording, by said background monitoring process, data items based on said monitoring;

determining, by said background monitoring process, a geographic location of the mobile user terminal;

associating, by said background monitoring process, said recorded data items with position information element that indicate a geographic position of the mobile user terminal at time of recording; and

reporting, by said background monitoring process, the recorded data items with said position information elements to an application server in a data communication network to be used in a search service.

According to an embodiment of the invention, the monitoring comprises monitoring one or more of following parameters: altitude of the mobile user terminal, atmospheric pressure affecting on the mobile user terminal, orientation of the mobile user terminal, g-force affecting on the mobile user terminal, bending of the mobile user terminal, stretching of the mobile user terminal, angle of the mobile user terminal, number of applications in the mobile user terminal, number of active applications in the mobile user terminal, frequency of use of applications in the mobile user terminal, statistics of applications in the mobile user terminal, type of media played by an application in the mobile user terminal, details of media played by an application in the mobile user terminal, statistics of media played by an application in the mobile user terminal.

According to an embodiment of the invention, the monitoring comprises monitoring at least one physical parameter by a sensor device.

A further aspect of the invention is a method, comprising:

running a background monitoring process in a plurality of mobile user terminals of a communication system;

monitoring, by said background monitoring process in each of said plurality of mobile user terminals, application programs or at least one sensor in said respective mobile user terminal;

recording, by said background monitoring process in each of said plurality of mobile user terminals, data items based on said monitoring;

determining, by said background monitoring process in each of said plurality of mobile user terminals, a geographic location of said respective mobile user terminal;

associating, by said background monitoring process in each of said plurality of mobile user terminals, said recorded data items with position information element that indicate a geographic position of said respective mobile user terminal at time of recording;

reporting, by said background monitoring process in each of said plurality of mobile user terminals, the recorded data items with said position information elements to an application server in a data communication network;

providing, by said application server, a search service for searching with a search criterion among the data items reported by said plurality of mobile user terminals.

A still further aspect of the invention is a mobile user terminal comprising at least one processor and at least one memory including computer program code, the at least one memory and the computer program code configured to, with the at least one processor, cause the mobile user terminal at least to perform:

monitor, as a background monitoring process, application programs or at least one sensor in the mobile user terminal;

record, as a background monitoring process, data items based on said monitoring;

determining, as a background monitoring process, a geographic location of the mobile user terminal;

associating, as a background monitoring process, said recorded data items with position information element that indicate a geographic position of the mobile user terminal at time of recording; and

reporting, as a background monitoring process, the recorded data items with said position information elements to an application server in a data communication network to be used in a search service.

A still further aspect of the invention is a system comprising,

a plurality of mobile user terminals of a communication system, each mobile user terminal comprising at least one processor and at least one memory including computer program code, the at least one memory and the computer program code configured to, with the at least one processor, cause the mobile user terminal at least to perform;
a) monitor, as a background monitoring process, application programs or at least one sensor in said respective mobile user terminal;
b) record, as a background monitoring process, data items based on said monitoring;
c) determine, as a background monitoring process, a geographic location of said respective mobile user terminal;
d) associate, as a background monitoring process, said recorded data items with position information element that indicate a geographic position of said respective mobile user terminal at time of recording;
e) report, as a background monitoring process, the recorded data items with said position information elements to an application server in a data communication network;

said application server comprising at least one processor and at least one memory including computer program code, the at least one memory and the computer program code configured to, with the at least one processor, cause the application server at least to provide a search service for searching with a search criterion among the data items reported by said plurality of mobile user terminals.

A still further aspect of the invention is a method comprising:

receiving at an application server in a data communication network data items reported by a plurality of mobile user terminals, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording;

providing, by said application server, a search service for searching with a search criterion among the data items reported by said plurality of mobile user terminals.

A still further aspect of the invention is an application server comprising at least one processor and at least one memory including computer program code, the at least one memory and the computer program code configured to, with the at least one processor, cause the application server at least to perform:

receive data items reported by a plurality of mobile user terminals, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording;

provide a search service for searching with a search criterion among the data items reported by said plurality of mobile user terminals.

A still further aspect of the invention is a method comprising searching, by a mobile user terminal, data items reported by a plurality of other mobile user terminals to an application server in the data communication network, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording; said searching further comprising providing a selection view based on the indexing records stored in the application node, the position selection view comprising a number of separate coordinate elements dividing the geographic area into a mesh of subareas, the appearance of the coordinate elements on the map view varying according to the proportion of interesting data items in each specific subarea based on position information elements of the indexing records of said plurality of mobile user terminals stored in the application node, each coordinate element corresponding to at least one position information element.

A still further aspect of the invention is a mobile user terminal comprising at least one processor and at least one memory including computer program code, the at least one memory and the computer program code configured to, with the at least one processor, cause the mobile user terminal at least to perform:

search, by a mobile user terminal, data items reported by a plurality of other mobile user terminals to an application server in the data communication network, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording; said searching further comprising

provide a selection view based on the indexing records stored in the application node, the position selection view comprising a number of separate coordinate elements dividing the geographic area into a mesh of subareas, the appearance of the coordinate elements on the map view varying according to the proportion of interesting data items in each specific subarea based on position information elements of the indexing records of said plurality of mobile user terminals stored in the application node, each coordinate element corresponding to at least one position information element.

In embodiments of the invention, the data items may include data items relating to characteristics of media played in media player applications in the plurality of mobile user terminals.

In embodiments of the invention, the appearance of the coordinate elements on the map view varies according to the proportion of a genre or another characteristic of the media in each specific subarea.

### BRIEF DESCRIPTION OF THE DRAWINGS

In the following the invention will be described in greater detail by means of exemplary embodiments with reference to the attached drawings, in which

FIG. 1 illustrates a number of communication endpoints configured to communicate over a communication network;

FIG. 2 illustrates a reference configuration of an application node in which the invention may be embodied;

FIG. 3 illustrates a functional description of a user terminal in which the invention may be embodied;

FIG. 4 illustrates a procedure for providing data elements in a user terminal illustrated in FIG. 3;

FIGS. 5A and 5B illustrate further embodiments of the basic procedure;

FIG. 6 illustrates a basic procedure for receiving data elements in an application node;

FIG. 7 illustrates a basic procedure for selecting and retrieving data elements in a user terminal;

FIGS. 8A, 8B and 8C show exemplary data item views;

FIG. 9 illustrates a further embodiment of the basic procedure for selecting and retrieving data elements in a user terminal;

FIG. 10 illustrates a basic procedure for retrieving data elements in an application node;

FIG. 11 illustrates a further embodiment in the application node;

FIGS. 12A and 12B illustrate schematically alternative configurations of a basic data item;

FIG. 13 illustrates a basic procedure for provision of associated data items to the user terminal

FIG. 14 illustrates a further example wherein the an application program according to embodiments of the invention may be a monitoring program or process run in the background of other application programs;

FIG. 15 illustrates an exemplary embodiment wherein sensor readings in a plurality of mobile user terminals are monitored and reported to an application server;

FIG. 16 shows a flow diagram illustrating an example of operation of a user terminal according to an embodiment of the invention;

FIG. 17 shows a flow diagram illustrating an example of operation an application server according to an embodiment of the invention;

FIG. 18 shows a flow diagram illustrating an example of search operation of a user terminal according to an embodiment of the invention;

FIGS. 19, 20, 21 and 22 illustrate examples of a user interface (UI) map views which may be displayed in a consuming user terminal.

### SOME EMBODIMENTS OF THE INVENTION

It is appreciated that the following embodiments are exemplary. Furthermore, although the specification may in various places refer to “an”, “one”, or “some” embodiment(s), reference is not necessarily made to the same embodiment(s), or the feature in question does not only apply to a single embodiment. Single features of different embodiments may be combined to provide further embodiments.

The present invention is applicable to a communication system that is capable of delivering data items between communicating endpoints. A variety of systems applying a variety of communication technologies may be used separately or in combinations to implement the embodiments of the invention. Communication systems and technologies evolve continuously, and embodiments of the invention will require a number of modifications that, as such, are obvious for a person skilled in the art. All words and expressions of this specification should be interpreted broadly, as they are intended merely to illustrate, not to restrict, the embodiments.

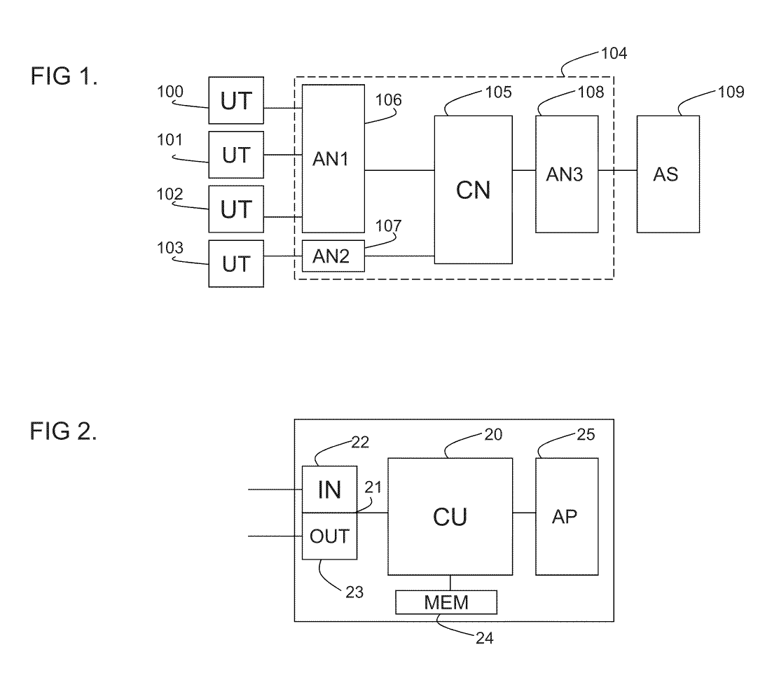

In the following, some embodiments of the invention will be described in the context of an exemplary communication system that provides fixed and wide area connectivity to mobile user equipment, however, without restricting the embodiment to any particular connectivity types. An embodiment of a communication system according to the present invention is illustrated in FIG. 1. It should be noted that only elements necessary for illustrating the invention are shown. It is apparent to a person skilled in the art that actual systems comprise other functions and structures that are not necessarily discussed or depicted in more detail herein.

The configuration shown in FIG. 1 is a logical representation of basic system architecture of an embodiment of the present invention and identities functional entities thereof. Each of the shown entities represents a grouping of functional entities. On the other hand, each of the functions may be realized in a single physical entity or be distributed over multiple physical entities.

FIG. 1 illustrates a number of communication endpoints 100, 101, 102, 103, 109 that are configured to communicate over a communication network 104. The communication network 104 typically comprises at least one or more core networks 105 that provide network services, and one or more access networks 106, 107, 108 through which the communication endpoints access these core network services. Core network 105 represents a transmission facility that interconnects lower-speed distribution networks, like access networks. Access networks 106, 107, 108 represent transmission facilities that provide final transmission laps to the communication endpoints 100, 101, 102, 103, 109. Communication endpoints represent herein system elements that source and sink data streams of a defined communication protocol layer. In the current embodiment an endpoint may be implemented in any fixed, mobile or portable device with connectivity to at least one access network of the communication network 104 and comprising an application that is configured to receive and transmit information over the protocol layers applied in connectivity of the device. Communication endpoints shown in FIG. 1 are illustrated by means of a number of user terminals 100, 101, 102, 103 as well as an application node 109, connected to the communication network 104.

As an access network AN1 for mobile user terminals, a communication network 105 may comprise a radio network subsystem 106. The radio network subsystem 106 may comprise one or more radio network controllers and one or more base tranceiver stations. A base tranceiver station performs air interface layer processing (for example, channel coding and interleaving, rate adaptation, etc.) to interface with user equipment 100, 101, 102, 103. The base transceiver stations form a coverage area within which the mobile user equipment may send and receive information. As the user moves around the network, the mobile user equipment will handoff to various cell sites during calls, or while waiting between calls it will reselect cell sites. A radio network controller is a network node responsible for the control of the radio resources of one or more base tranceiver stations and interfaces the core network 105. For a person skilled in the art it is clear that the radio access network AN1 may comprise one or more interconnected radio network subsystems.

Mobile user terminal is user equipment primarily arranged to operate in a cellular network. By handing over the connection from one cell to another cell, mobile user equipment may access network services also during movement. Mobile user equipment functions within a radio access network infrastructure together with the software, applications, and content associated with the device, and thereby provides to its user connectivity. A user equipment may be a simple terminal that is able to communicate with one media type service (for example, speech) only or it can range to a terminal for diverse services that acts as a service platform and supports loading and execution of various functions related to these services. In the current exemplary embodiment of accessing the radio access network, the mobile user terminal may be implemented as any mobile equipment or any type of computer device to which a fixed or detachable radio interface element (for example, a card phone) has been coupled to provide a connection to the radio access network.

Other types of user terminals are connected to the system by means of their respective access types. A communication network 105 may also comprise a fixed network subsystem 107 to provide access network AN2 for fixed user terminals. A fixed network subsystem comprises a number of fixed access points to which user terminals may be connected in order to connect to the services of the core network. Fixed access points may be used by fixed and portable terminals. A portable terminal may be moved from point to point but may only used at a fixed point. A fixed terminal is substantially permanently connected to a fixed access point assigned to it. It should be noted that the invention may be applied in mobile, portable and fixed user terminals.

A communication endpoint does not need to be operated by a user but may be implemented as computer that serves other entities accessible through the same communication system by operating as the other entities request. An application node 109 represents here a server or a program in a computer in a distributed network that provides the business logic for an application that implements the functions according to the invention. Depending on the implementation, the application node 109 may be connected to the communication network 105 directly without an access network, or indirectly through an access network AN3 108. In FIG. 1, AN3 represents a telecommunications network between a local exchange of the core network and the application node 109.

FIG. 2 illustrates a functional description of an application node in which the invention may be embodied. An application node may be any networked computer element that is accessible to the participating user equipment using their respective primary connectivity type. Advantageously an application node is also capable of accessing the charging interfaces of the participating user equipment for the purpose of generating charging records on the implemented operations.

The application node of FIG. 2 comprises a processing unit 20, an element for controlling the operations and executing functions of the application node. The processing unit 20 comprises an arithmetic logic, a number of special registers and control circuits. The processing unit may be implemented as a single integrated circuit or as a combination of a number of integrated circuits.

The application node of FIG. 2 also comprises a communication unit 21 configured with receiving unit 22 for receiving information from the network interface and processing it for inputting to the processing unit 20, as well as with transmitting unit 23 for receiving information from the processing unit 20, and processing it for sending via the network interface. The implementation of such a communication unit is generally known to a person skilled in the art. The connection type used for communication with other communication end-points is not relevant for the invention; basically the application node may operate towards the other endpoints through its own access network, the core network and any access network of the respective communicating party. The application node may also be implemented as part of the core network.

Connected to the processing unit is a memory unit 24, a data medium where computer-readable data or programs or user data can be stored. The memory unit typically comprises storage elements that allow both reading and writing (RAM), and storage elements whose contents can only be read (ROM). The application node may also comprise a user interface unit (not shown) for inputting data by the user for internal processing in the application node, and for outputting user data from the internal processes of the application node. Examples of applicable input devices comprise a keypad, a touch screen, a microphone, or the like. Examples of applicable output devices comprise a screen, a touch screen, a loudspeaker, or the like. Through the user interface unit an administrator of the application node may control the operations of the application node and provision possible new users for the service.

According to the invention, the application node of FIG. 2 further comprises an application unit 25, an element that comprises a logical collection of functions for implementing the embodiment of the present invention. The application unit may be implemented, for example, as series of computer tasks defined in a programming language. For a person skilled in the art it is cleat that a combination of functions that provide a capability for the interworking of application node invocations for a specific purpose may comprise functions specifically configured in the application unit and/or basic functions available in the application node. The processing unit, the communication unit, the memory unit and the application unit of the application node are electrically interconnected for performing systematic execution of operations on the received and/or stored data according to predefined, essentially programmed processes of the unit. In solutions according to the invention, these operations comprise the basic and embodied functionality of the application node as will be described in more detail in the following.

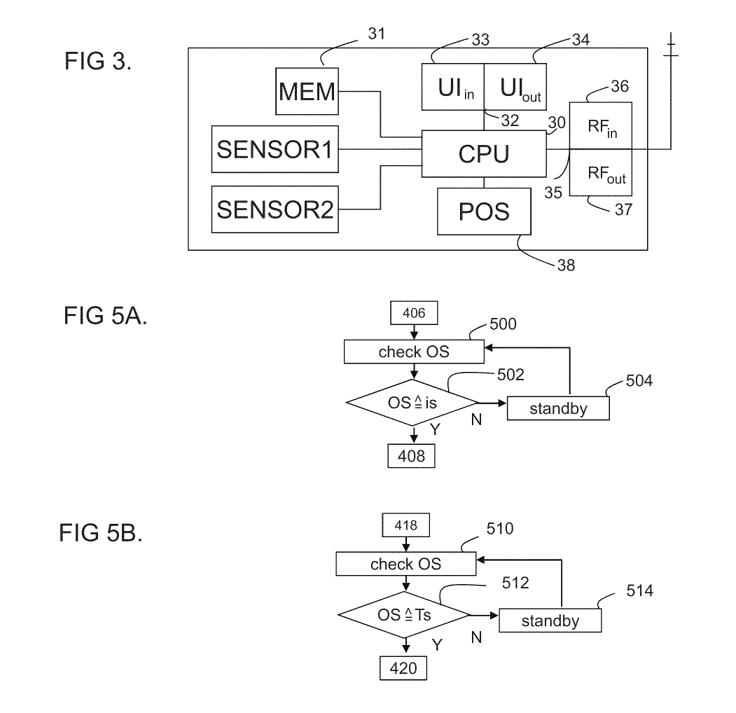

Correspondingly, FIG. 3 illustrates a functional description of a user terminal in which the invention may be embodied. A mobile user equipment is used as an example. Also the user equipment may comprise a processing unit 30, an element for controlling the operations and executing functions of the user equipment. The processing unit 30 may comprise an arithmetic logic, a number of special registers and control circuits, and may be implemented as a single integrated circuit or as a combination of a number of integrated circuits.

Also connected to the processing unit may a memory unit 31, a data medium where computer-readable data or programs or user data can be stored. The memory unit may comprise RAM and ROM elements. The user equipment UE may also comprises a user interface unit 32 with user input unit 33 for inputting data by the user for internal processing in the user equipment, and user output unit 34 for outputting user data from the internal processes of the unit. Examples of applicable input devices may comprise a keypad, a touch screen, a microphone, or the like. Examples of applicable output devices comprise a screen, a touch screen, a loudspeaker, or the like.

The mobile user equipment UE may also comprise a radio communication unit 35 configured with a receiving unit 36 for receiving information from the base transceiver station of the radio network subsystem over the air interface and processing it for inputting to the processing unit 30, as well as with a transmitting unit 37 for receiving information from the processing unit 30, and processing it for sending via the air interface to the base tranceiver station of the radio network subsystem. The implementation of such radio communication units is generally known to a person skilled in the art.

The user equipment may advantageously comprise also a positioning unit 38 for determining the geographical position of the user equipment and provide the position data for subsequent use in the functions of the user equipment. An example of positioning units is an integrated Global Positioning System (GPS) device. It should be noted that a separate positioning unit is optional in that the position information associated with data items can be provided in other ways also, for example input manually by the user. Other automatic positioning schemes are also available, for example, positioning based on base tranceiver station identity or measurements carried out in the base transceiver stations. The user equipment may further comprise one or more sensors SENSOR1 and SENSOR2 for monitoring physical parameters which may include, without restricting embodiments of the invention to these examples, altitude of the mobile user terminal, atmospheric pressure affecting on the mobile user terminal, orientation of the mobile user terminal, g-force affecting on the mobile user terminal, bending of the mobile user terminal, stretching of the mobile user terminal, angle of the mobile user terminal.

The user equipment may also comprise one or more local communication units (not shown) for enabling transmission and reception of information locally, for example, a device implementing any of the following technologies: Bluetooth, Infrared Data Association (IrDA), Radio Frequency Identification (RFID), Digital Enhanced Cordless Telecommunications (DECT), Dedicated Short Range Communications (DSRC), HIPERLAN, HIPERMAN, Institute of Electrical and Electronics Engineers (IEEE) 802.11, Ultra-wideband (UWB), Institute of Electrical and Electronics Engineers (IEEE) 802.16 (Wi-MAX), xMax, ZigBee, Institute of Electrical and Electronics Engineers (IEEE) 802.16 (WPAN), Wireless USB. The user equipment also comprises one or more interface connections for direct provisioning of terminal software. Access to such terminal software format is available to a restricted group of users only. It is clear that the user equipment may also comprise other functional units without deviating from the scope of protection.

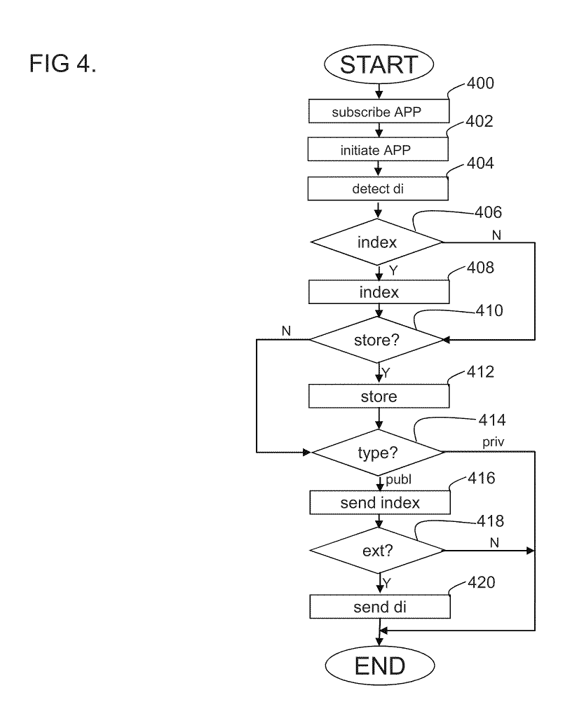

FIG. 4 illustrates a basic procedure for providing data elements in a user terminal illustrated in FIG. 3. The procedure begins in a state where the user terminal is switched on and registered into the communication system and thus ready to send and receive data over the air interface. In step 400, the user terminal subscribes an application program APP. Subscription refers here to a contract between an application service provider and a subscriber. At contracting a set of communication protocols are agreed and possibly a charging relationship is formed. In the user terminal, the subscription is provisioned by means of an application program made accessible in the user terminal. The application program may be delivered to the user terminal through the communication unit over the air interface, through any of the local communication interfaces of the user terminal, or provisioned directly to the user terminal through the interface connections of the user terminal.

At some point of operation the user initiates (step 402) the application, for example by entering a defined key sequence in the keypad, or activating a defined icon in the screen of the user terminal. The application program may be a background monitoring program which is run in the background of other application programs and which substantially invisible to the user. After initiation the application provides for user activation a function for data item generation, for example by means of a background monitoring of sensors or other applications. It is clear that in a full application implementation, various functional or other options available to the user at a particular operating stage are provided as a combined selection view, where the selection can be made in several ways. The layout and implementations of the views and menus through which the function is made available to the user are not relevant for the embodiment and will not be discussed in more detail herein.

At some point of operation the user equipment detects (step 404) a data item, for example by means of a background monitoring of sensors or other applications. A data item is a combination of one or more information elements, joined together at least for transmission purposes. Information elements of the data item may comprise user data or index data. User data carries content that may be consumed by users, index data comprises additional information that is associated with the data item but is not essential in consumption of the data item. User data information elements in the data item may be in any format in any media type. Index data information elements need to be in at least one of the formats that can be interpreted by various communication parties

A data item may be generated in the user terminal, received locally into the user terminal through any of the local communication devices, or received from another user via the communication system. Data items may be generated in the user terminal by photographing, video imaging, recording, monitoring physical parameters by sensors, inputting text, and adopting output information from a user terminal application, like a game, for example, or monitoring monitoring internal status, operation, applications and/or statistics of the user terminal. By choice of the user or as an automated function of the user terminal, information on the existence of the data item is input to the application program and a procedure for data item processing is initiated in the user terminal.

The user terminal checks (step 406) whether to index the data item. As discussed above, indexing may be performed by including indexing information elements to the data item. Indexing may be performed to all data elements or only to selected data items. The decision whether a data item is to be indexed may be prompted from the user via the user interface or it may be determined automatically according to a predefined scheme. For example, at subscribing the user may create a profile that includes one or more indexing conditions that a data item need to fulfill in order to be indexed. For example, a condition may include a definition that data items created with a camera integrated to the user equipment will by default be indexed. It is clear that a variety of schemes may be applied without deviating from the scope of protection.

According to the invention, the indexing data comprises an information element that indicates a position to be associated with the data item. Indexing data may be generated automatically by the user terminal and/or prompted from the user. For example, the position information element may be derived as a coordinate determined with the positioning unit of the user terminal or provided as a name of a location (e.g. ‘Helsinki’) typed in by the user. In addition, the user terminal may include in the data item a number of other indexing information elements, for example, an indexing information element that indicates the data item to be public, an indexing information element that indicates a time of generation of he data item, an indexing codeword that describes the subject of the content, for example. A variety of information elements applicable for annotating the content may be used without deviating from the scope of protection. All or part of the indexing information elements of the data item are combined into an indexing record of the data item.

If the check is positive, the user equipment will perform indexing (step (408). If the check is negative, the procedure will continue directly to the next step where the user terminal checks (step 410) whether or not to store the data item into a user terminal memory that is assigned for the use of the application. If the check is positive, the data item is stored (step 412) to the user terminal. If the check is negative, the procedure will continue directly to the next step where the user equipment, according to the invention, further checks (step 414) whether the data item will be treated as ‘public’ or ‘private’.

Public data item refers to data items that after their submission to the system are inherently accessible to users of the application service. Access to public data items may be restricted by additional control definitions provided in the application program protocols. Private data item refers to data items that are inherently accessible only to the user that submits them to the system. Access to private data may be granted by additional control definitions provided in the application program protocols. The decision whether a data item is to be treated as public or private may be prompted from the user via the user interface or it may be determined automatically according to a predefined scheme. For example, at subscribing the user may create a publication profile that includes one or more conditions that a data item need to fulfill in order to be marked public. For example, a condition may include a definition for an area and a definition that data items created with a camera integrated to the user equipment within that defined area may by default be marked public. It is clear that a variety of schemes may be applied without deviating from the scope of protection.

If the data item is to be treated as public, the user terminal sends (step 416) the indexing record of the data item to a defined application node. The address of the application node is configured to the user terminal, for example, at subscribing the application service and the connectivity to the application node is provided via the communication system. If the data item is to be treated as private, the indexing record is not forwarded outside of the user equipment, and the embodied procedure terminates.

The user terminal further checks (step 418) whether to transmit the data item to a predefined external database assigned to the application service. If the check is positive, the user terminal sends (step 420) the data item to the predefined external database. If the data item is to be treated as private, the data item is not forwarded outside of the user equipment, and the embodied procedure terminates.

FIG. 5A illustrates a further embodiment of the basic procedure of FIG. 4. Indexing of the data items may be performed directly after the decision to index is available. Alternatively, the user terminal may be configured to detect operational states (OS) during which indexing may be performed with least interference to other essential procedures of the user terminal. An example of such operational states is an idle state during which the user terminal is not sending or receiving user data through the telecommunication system. Such states are referred to as indexing states (IS). The procedure illustrated in FIG. 5A begins when the user terminal has detected that indexing would be performed. In step 500, the user terminal checks (step 502) its operating state to see whether is matches with the one or more predefined indexing states. If the check is positive, the user terminal continues to step 408. If the check is negative, the user terminal performs a standby operation (step 504) after which it again checks whether the indexing state exists.

FIG. 5B illustrates another further embodiment of the basic procedure of FIG. 4. Data items generated by a user terminal may be stored in one or more of the memories in the user terminal, or transmitted for storing to an external database. Data items that are transmitted from the user terminal to an external storage may be transmitted directly after the decision to transmit is available. Alternatively, the user terminal may be configured to detect operational states (OS) during which transmission of data items may be performed with least interference to other essential procedures of the user terminal. An advantageous state for initiating transmission of data items is, as in the embodiment of FIG. 5a, the idle mode of the user terminal. Such states are referred to as transmission states (TS). The procedure illustrated in FIG. 5B begins when the user terminal has detected that a data item would be transmitted. In step 510, the user terminal checks (step 512) its operating state to see whether is matches with the one or more predefined transmission states. If the check is positive, the user terminal continues to step 420. If the check is negative, the user terminal performs a standby operation (step 514) after which it again checks whether the transmission state exists.

The standby operation in FIGS. 5A and 5B may comprise waiting for a predefined period before performing a new check. Alternatively, the standby operation may comprise interaction with the mobility management and radio resource functions of the user terminal such the procedure will be paused, and as soon as the desired indexing or transmission state (for example, the idle mode of the user terminal) is entered, the procedure will be automatically resumed. Other standby operations are possible without deviating from the scope of protection.

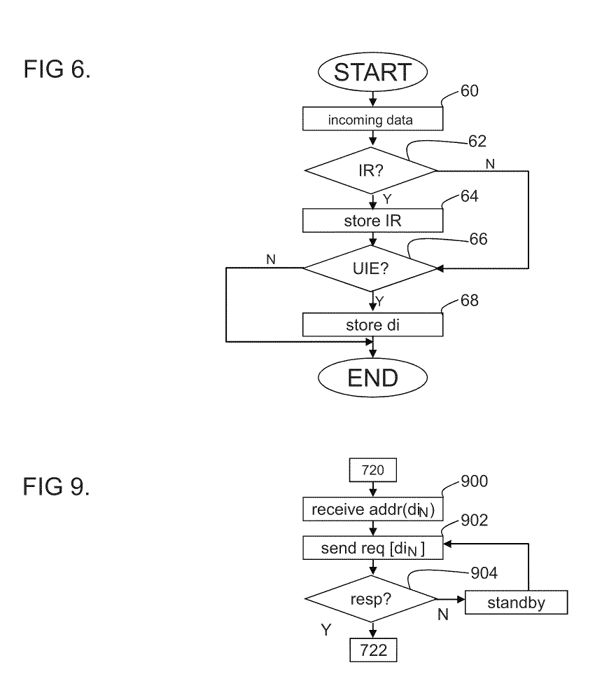

FIG. 6 illustrates a basic procedure for receiving data elements in an application node illustrated in FIG. 2. In the beginning the application node is switched on detects (step 60) incoming data. The application node checks (step 62) whether the data comprises an indexing record of a data item. If the check is positive it stores (step 64) the indexing record and thus makes the record and the indexing information elements into a data item index registry. The data item index registry comprises indexing records of data items received and recorded by the application node. This data item index registry is available for search and/or data retrieval as will be described in more detail later on. The storing step may comprise further functions where the index is, for example, checked, verified, and/or complemented with indexing information elements by the application node. If the check is negative, the procedure continues directly to the next step where the user terminal checks (step 66) whether the data comprises user data information elements (UIE). If the check is positive it stores (step 68) the user data information elements and thus makes them available for data retrieval. Data elements may be stored in a database integrated to or directly accessible from the user terminal, or in one or more external databases accessible through the communication system. The application node will record the storing operations such that for data items whose indexing record is available for search, the address of the storage is derivable for data retrieval.

It is appreciated that provision of data items in a plurality of locations and making them publicly available provides a new independent media channel that considerably increases the amount of consumable information. The information comes directly from content generators that, for some consumers, may represent increased authenticity of the newscast. The information may be made available without editorial delays inherently associated with the conventional news broadcasts. The associated position information enables a variety of search function that may be utilized to improve the accuracy of the searches, as will be discussed herein.

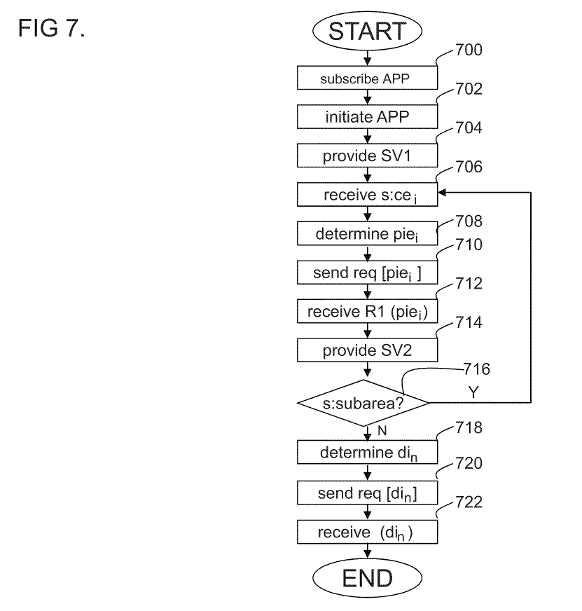

FIG. 7 illustrates a basic procedure for selecting and retrieving data elements for consumption in a user terminal illustrated in FIG. 3. The application service may be separately such that a user may act as a provider of data elements or as a consumer of data elements or as both. The embodiment of FIG. 7 illustrates operations from the point of view of a user terminal used for consuming the data elements. For conciseness, definitions for same terms are not repeated here, but reference is made to description of FIG. 4. Thus the procedure begins in a state where the user terminal is switched on and registered into the communication system and thus ready to send and receive data over the air interface. In step 700, the user terminal subscribes an application program APP. At some point of operation the user initiates (step 702) the application.

The application provides (step 704) for user selection an area selection view that comprises a plurality of coordinate elements, where each coordinate element corresponds to an actual geographical area, and thereby to a group of one or more position information elements that may be included in the indexing records of data items. In the area selection view the user is prompted to select one or more coordinate elements and thereby choose a geographic area for a subsequent data item view. As discussed earlier, the format of the menus and selections is, as such, not relevant for the scope of protection. Furthermore, the area selection is optional such that the user may be merely shown a common view that illustrates the geographic area from which data items will by default be searched. However, advantageously, the area selection view provides options for scoping the search to a defined geographical area of interest. In addition to position-related restrictions, the user may be provided with a possibility to define some further search conditions, based on the other indexing information elements. For example, the further search conditions may limit the search to data items generated within a defined time period, or data items that comprise a particular indexing codeword, or data may be searched by a group of users that have generated data or any combination of these etc.

When the user terminal receives (step 706) a selection of one or more coordinate elements ceᵢ, the user equipment determines (step 708) the position information elements pie, that correspond to the selected coordinate elements and sends (step 710) to the application node a message that comprises an indication on the determined position information elements pie, and a request to provide information on data items, the indexing record of which comprises any of the determined position information elements. The information requested from the application node on data items may vary according to the implementation, but comprises at least the position information for each of the data items to be included in the data item view.

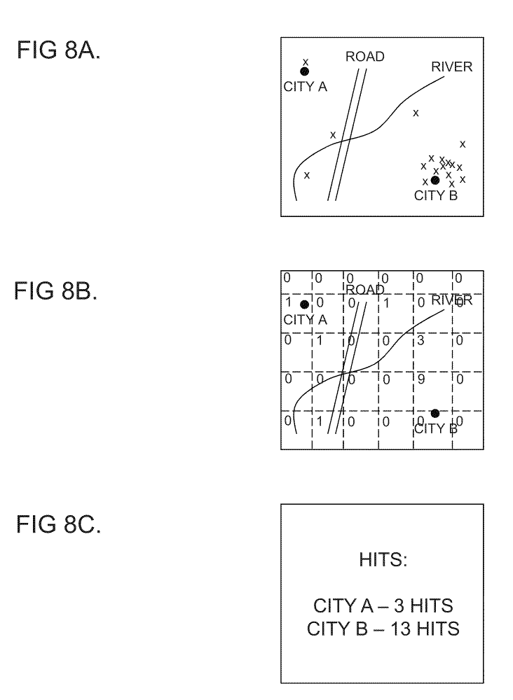

When the user terminal receives (step 712) the requested information it outputs (step 714) to the user a data item view that provides information on the availability of data items associated by indexing with the selected geographical area, the availability information provided in such form that the amount of available data elements in defined subareas of the geographical area of the data item view is shown. The data item view again that comprises a plurality of coordinate elements, where each coordinate element corresponds to an actual geographical area, and thereby to a group of one or more position information elements. In addition the data item view provides an indication on the availability of data items in that particular geographic area. A data element is available in a geographic area when its position information element corresponds to the coordinate element that, on the other hand, corresponds to the particular geographic area. The format of the first selection view and the indications on data items may vary according to the implementation. FIG. 8A shows an exemplary data item view where the view is output in the user terminal screen as a map such that one pixel of the map corresponds to an actual geographical area. In case the search base formed by the indexing records of data items in the data item view comprises at least one data item indexed with a position information element that corresponds with the coordinate element, the pixel corresponding to the coordinate element is shown as contrasted from the map. In FIG. 8A, the contrast is accomplished by an asterisk output on the corresponding coordinate element. A further effect may be produced by changing the brightness or color of the pixel according to the amount of data items per the coordinate element of the pixel.

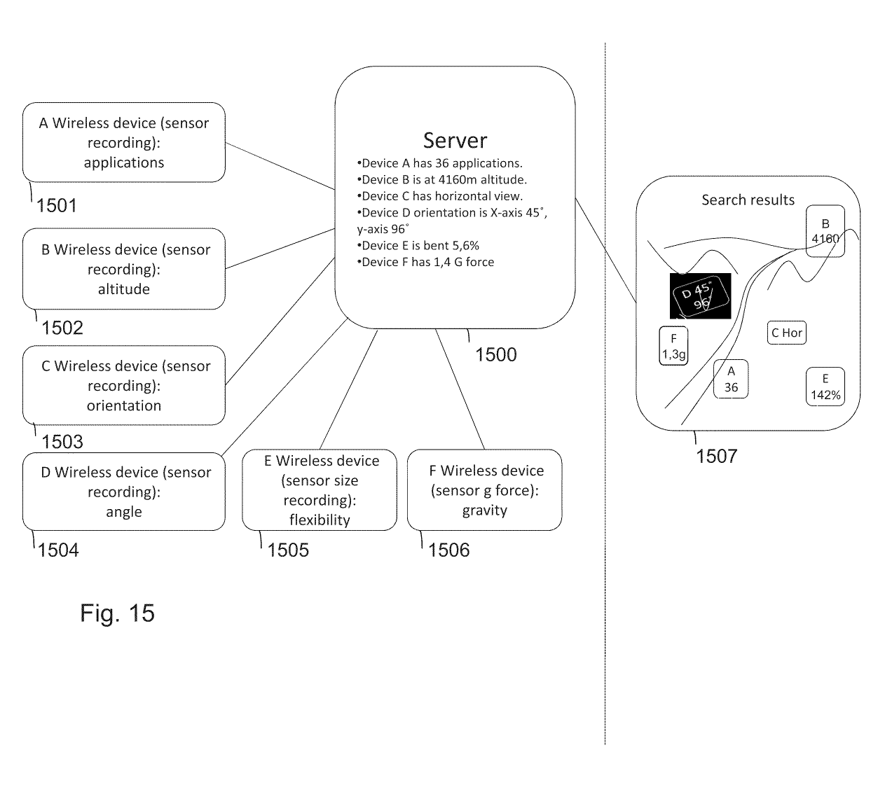

FIGS. 8B and 8C show alternative views illustrating the availability of the same data items in the same geographic area. In FIG. 8B the geographic area is divided into a mesh of subareas and the number of available data items in each subarea is printed in the corner of the respective subarea. In FIG. 8C the geographic area is divided into two subareas corresponding to the division of the land around the two cities CITY A and CITY B by the river RIVER. The number of data items in each of the subareas is listed in the data item view. For a person skilled in the art it is clear that alternative implementations of the data view may be used without deviating from the scope of protection. Further examples of the data view are illustrated below in FIGS. 15 and 19-22.

The granularity of the first view may be insufficient so the selection by the user may comprise a selection of one of the subareas such that the subarea becomes a new geographic area of interest. Thus the user terminal checks (step 716) whether the selection points to a subarea of the data item view. If the check is positive, the procedure will return to step 706 with a new set of coordinate elements ce_{i,}. If the check is negative, the selection points to one or more data items that the user wishes to be retrieved. It is appreciated that the data item views may be configured to change according to the level of detail. For example, viewing the availability of data items may started from a geographic area that corresponds to a map view of whole USA and scoped in successive data item views to the level of a list of data items in a particular airport in USA. From this list the user may select the data items he wishes to download to his or her user terminal.

The user terminal determines (step 718) the data items diₙ selected for retrieval and sends (step 720) to the application node a a message that comprises an indication on the selected data items diₙ and a request for retrieving the data items. The procedure end when the user terminal receives (step 722) the requested data items.

Showing the availability of data items in the context of their respective geographical area provides for the user a consistent and systematic way to approach the desired subject and search for the relevant data items.

FIG. 9 illustrates a further embodiment of the basic procedure of FIG. 7. As will be discussed in more detail later on, the retrieval of data items may be performed by the application node such that after requesting the data items, the user terminal may receive the retrieved data items or notification from the application node on unsuccessful retrieval of one or more data items. Such case is illustrated in FIG. 7. Alternatively, the application node may act only as an indexing party and provide addresses to the data storages from which the data items may be retrieved. For example, some data items may be stored and available for download in the user terminal where it was originally created. In such situation the multiplicity of storages that are uncontrollably available or unavailable for access and the delay on the retrieval operation may exceed the service session, i.e. the time that the user is willing to remain standby to interact for retrieving the data item. This could potentially severely handicap the user experience of the service. The disadvantage may, however, be avoided by an arrangement shown in FIG. 9.

The procedure of FIG. 9 begins when the user terminal has sent a request for data items diₙ to the application node and the application node does not provide the data item but an address Addr(diₙ) from which the data item may be retrieved. When the user terminal receives (step 900) the address Addr(diₙ) it generates a request for the data item and sends (step 902) it to a communication endpoint in the provided address. The user terminal checks (step 904) whether a response is received within a defined period of time or not. If the check is positive, it means that the communication endpoint is accessible, the response comprises the data item and the procedure may continue as in step 722 of FIG. 7. If not, the communication endpoint is not accessible, and the retrieval is not successful. In response to a negative check, the user terminal initiates a standby procedure (step 906) after which the request is resent to the communication endpoint. The standby procedure may be any procedure that keeps the data retrieval procedure automatically running such that whenever the communication endpoint becomes accessible again, the data item will be automatically retrieved and provided for consumption. Standby operation may comprise, for example, waiting for a predefined period before performing a new check. Other standby operations are naturally possible without deviating from the scope of protection.

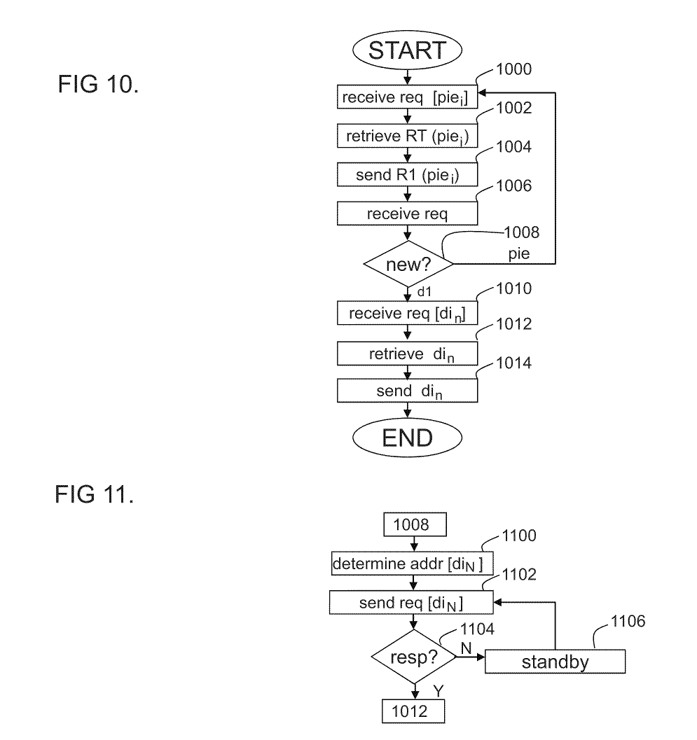

FIG. 10 illustrates a basic procedure for retrieving data elements in an application node embodied in FIGS. 2 and 6. If not specified otherwise, definitions of similar terms and notations may be referred from the description of the earlier embodiments. The procedure begins when the application node is switched on and the application service program is running in the application node. A plurality of data items are received and recorded to the data item index registry of the application node. The application node receives (step 1000) from one of the user terminals a message that comprises an indication on determined position information elements pie, and a request to provide information on data items, the indexing record of which comprises any of the determined position information elements. The application node searches the data item index registry and on the basis of information in the indexing records generates the requested information on the selected data items RI[pieᵢ)]. It should be noted that other indexing information elements may be additionally used for limiting the amount of searched data items. Provision of search criteria for conventionally annotated information is generally known to a person skilled in the art and will not be described here in more detail.

The application node generates a response comprising the requested information RI[pieᵢ)] and sends (step 1004) it to the requesting user terminal. When a new request from the user terminal arrives (step 1006), the application node checks (step 1088) the type of the new request. In case the new request again comprises an indication on determined position information elements pie, and a request to provide information on associated data items, the procedure returns to step 1000 with a new set of position information elements. In case the new request comprises a request to retrieve one or more data items (step 1010), the application node initiates a procedure for retrieving (step 1012) the requested data item or data items. When data items are retrieved, the application node sends (step 1014) the data items to the requesting user terminal. Data items may be forwarded to the user terminal according to a predefined schedule, for example, one by one at the time they become available, combined into groups and delivered by a separate invitation that the user terminal gives when it is ready to receive information. It is clear that other delivery schedules may be applied without deviating from the scope of protection.

As discussed in context of FIG. 9, the application node may act to retrieve the requested data items and deliver them to the requesting user terminal, as shown in FIG. 10. Alternatively, it may act as a mediator that enables the search for a data item and returns to the requesting user equipment one or more addresses from which the data item may be retrieved, but does not itself retrieve the data items. In such case step 1012 of FIG. 10 would illustrate the act of sending addresses addr(diₙ) to the requesting user terminal. The application node may assume either or both of the above roles, depending on the implementation. For example, the application node may be configured to retrieve the information from internal or external databases directly available to it, but for data items only stored in the user terminals, merely provide the address to the other communication endpoint from which the data item may retrieved.

However, in case the application node assumes the responsibility for retrieving the data item, the problem of accessibility of data items, as discussed in connection with FIG. 9, arises. FIG. 11 illustrates a procedure for overcoming the problem encountered in operating on a plurality of data storages whose availability for access varies uncontrollably. The procedure beings when the user equipment at step 1010 has received a request for a particular data item di_{N} stored in a user terminal. The application node determines (step 1100) from the data item index registry the address of the data item. The address of the data item corresponds to an address of the user terminal where the data item is stored. The application node sends (step 1102) to the user terminal a message that indicates the identity of the data item and a request for retrieval of the data item. The application node checks (step 1104) whether a response is received within a defined period of time If the check is positive, it means that the communication endpoint is accessible, the response comprises the data item and the procedure may continue as in step 1012 of FIG. 10. If not, the communication endpoint is not accessible, and the retrieval is not successful. In response to a negative check, the user terminal initiates a standby procedure (step 1106) after which the request is resent to the communication endpoint. The standby procedure may be any procedure that keeps the data retrieval procedure automatically running such that whenever the communication endpoint becomes accessible again, the data item will be automatically retrieved and provided for consumption. Standby operation may comprise, for example, waiting for a predefined period before performing a new check. Other standby operations are possible without deviating from the scope of protection.

A group of conditions related to the indexing information elements and used for restricting the amount of data items may be combined into a search profile such that a search for data items on a particular point of interest may be easily searched at any time. For example, an interested fisherman may create a profile that follows the availability of data items in subareas crossed by the river of FIG. 8A and/or in the near vicinity of the river. Correspondingly, fishermen may agree that best catches will be photographed and shared through the application service. By activating the created profile, the fisherman may quickly browse the available pictures and be fully aware of the latest triumphs of the fellow fishermen. As another example, a person who drives to work along the road in FIG. 8A may create a profile that follows the availability of data items in the subareas through which the road passes. By making a search using this profile, the user may access first hand knowledge on occurrences, like accidents, in the road and whenever necessary reroute the drive.

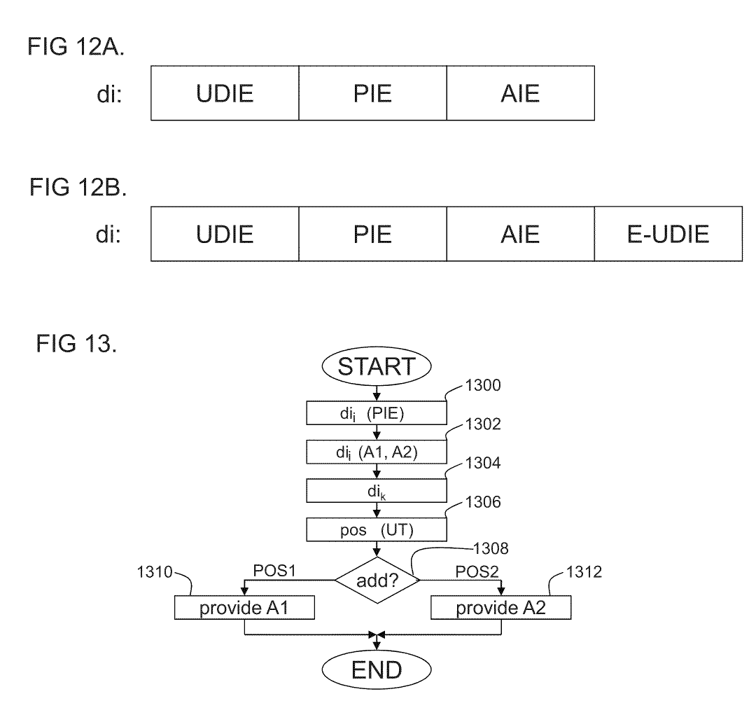

Typically, after a data item has been created and indexed its content cannot be changed anymore. A further embodiment of the invention enables interaction between users that have retrieved the data item. FIG. 12A illustrates schematically the configuration of a basic data item. The data item comprises a user data part UDIE that includes one or more user data information elements, and an indexing data part, which comprises a position information part PIE that includes one or more position data information elements and additional information part AIE that includes one or more additional information elements applicable for scoping the searches as discussed in connection with FIG. 7. FIG. 12B illustrates a data item applicable in a further embodiment of the invention. The data item comprises an editable information part E-UDIE that is configured such that the user may edit the existing content or add new content on top of the existing content. For example a user in Japan may submit a data item where the user information part comprises a picture of a comet X, the indexing data part comprises a codeword ‘comet X’, and the data item comprises an editable information part. In minutes another user in Sweden accesses the data item, adds an appreciative comment to the data item and resubmits the data item to the data item index registry. The application node detects that the data item is the same but the editable information part has been amended, and distributes the data item back to a defined group of user that have accessed the data item. The defined group may comprise, for example, all users that have accessed the data item, or the creator of the data item and any user that has earlier commented the data item. Other distribution schemes may be applied within the scope of protection. The arrangement allows instant contact and exchange of opinions for various parties interested in same topics. Thus, in addition to improving the possibilities to search interesting content, the solution provides a way to search for communicating parties with similar interests.

According to a further aspect of the invention, FIG. 13 illustrates a basic procedure for provision of associated data items to the user terminal. The possibility to provide further data items, for example advertisements, selected according to the codewords used in the search of data items has been conventionally used to create a commercial basis for provision of the data item distribution service. This mechanism provides a clear and quick procedure that allows advertises to focus their important information to target groups that are interested in the areas to which the codewords may be related. Another state of the art mechanism is provision of location-based information in cellular systems. For example, in a location based service, a user registered to a particular cell and requesting information on nearby restaurants may be positioned by the system and identity information on restaurants in the current cell and the neighboring cells is provided for his perusal.

These mechanisms can be significantly improved by further focusing the content of the information such that is more compatible with the possibilities to use the information. For example, an bar owner in Thailand might be interested to forward to a user that searched and retrieved a data item about a nearby beach an advertising invitation to his bar. This information would, on the other hand, not be that interesting to a user that at the time of retrieving the data item was in the USA. However, a US travel agent selling vacations to a resort at that beach would most likely be willing to provide some more information on their services to the user.

In line with the set example, the procedure of FIG. 13 starts at a situation where a user terminal has subscribed the service and the application program is running in the user terminal. The application node records a continuous accumulation of data items diᵢ, the indexing data of which includes a position information element (step 1300). Additionally, in the application node the data item is associated with at least two additional data items A₁, A₂, for example, advertisement data items (step 1302). When a user terminal retrieves (step 1304) a data item di_{K}, using the procedures disclosed in the examples above, the application node determines (step 1306) the position of the user terminal that retrieved the data item, and on the basis of the position determines (step 1308) which of the additional data items to provide to the consuming user terminal.

For example, if the position of the user terminal is POS1 that is within a defined range from the bar, additional data item A₁, for example an invitation to the happy hour in the same evening, is provided (step 1310) to the user terminal along with the data item. On the other hand, if the position of the user terminal is POS2 that is within a defined range from a particular travel agent, additional data item A₂, for example an advertisement and a quick link to the travel agents contact information, is provided to the user terminal along with the data item. Thus a data item associated with one position information may be used to deliver different types of messages to users in different geographical positions.

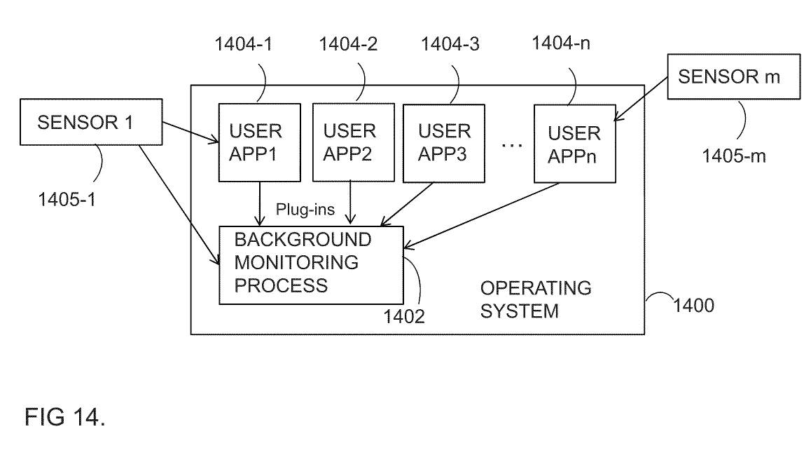

As explained above, an application program according to embodiments of the invention may be a monitoring program or process which, after activation by a user, may be run in the background of other application programs substantially invisibly to the user. An example embodiment is illustrated in FIG. 14. Operating system (OS) software 1400, consisting of programs and data, is run on a processing unit, such as the processing unit 30 shown in FIG. 3, and manages hardware resources, and provides common services for execution of various application software. In FIG. 14, a plurality of user applications 1404-1 . . . 1404-n are shown (n=1, 2, . . . ), which can be any user applications run on the terminal equipment. Examples of such user applications may include games, calendar, office tools, media players, social media applications, etc. A further application may be a background monitoring application 1402 according to exemplary embodiments of the invention. The background monitoring application 1402 may be run in the background of other application programs 1404-1 . . . 1404-n substantially invisibly to the user. The monitoring application 1402 may monitor of sensors 1405-1 . . . 1405-m (m=1, 2, . . . ) or other applications 1404-1 . . . 1404-n. The sensors 1405-1 . . . 1405-m may monitor physical parameters which may include, without restricting embodiments of the invention to these examples, altitude of the mobile user terminal, atmospheric pressure affecting on the mobile user terminal, orientation of the mobile user terminal, g-force affecting on the mobile user terminal, bending of the mobile user terminal, stretching of the mobile user terminal, angle of the mobile user terminal. The sensors 1405-1 . . . 1405-m may provide the measurement results to the background monitoring application 1402 either directly or via other user applications 1404-1 . . . 1404-n. The background monitoring application 1402 may monitor internal status, operation, applications and/or statistics of the user terminal by means of “soft sensors”, such as plug-ins, extensions, add-ons, etc., generally any interface between the monitoring application 1402 and other applications. The monitored internal status, operation, applications and/or statistics of the user terminal, which may include, without restricting embodiments of the invention to these examples, number of applications in the mobile user terminal, number of active applications in the mobile user terminal, frequency of use of applications in the mobile user terminal, statistics of applications in the mobile user terminal, type of media played by an application in the mobile user terminal, details of media played by an application in the mobile user terminal, statistics of media played by an application in the mobile user terminal. Using these “soft sensor”, the monitoring application 1402 may obtain information from the applications 1404-1 . . . 1404-n and/or the operating system 1400.

FIG. 15 illustrates an exemplary embodiment wherein among a plurality of mobile user terminals, a background monitoring application 1502 of a wireless user terminal A 1501 is monitoring (e.g. recording with soft sensors) applications in the user terminal; a background monitoring application 1502 of a wireless user terminal B 1502 is monitoring (e.g. recording with a physical sensor) altitude of the location of the user terminal; a background monitoring application 1502 of a wireless user terminal C 1503 is monitoring (e.g. recording with a physical sensor) orientation (e.g. horizontal/vertical orientation) of the user terminal; a background monitoring application 1502 of a wireless user terminal D 1504 is monitoring (e.g. recording with a physical sensor) an angle (e.g. tilting) of the user terminal; a background monitoring application 1502 of a wireless user terminal E 1505 is monitoring (e.g. recording with a physical sensor) flexibility (e.g. bending) of the user terminal; and a background monitoring application 1502 of a wireless user terminal F 1506 is monitoring (e.g. recording with a physical sensor) a gravity (e.g. G force) of the user terminal.

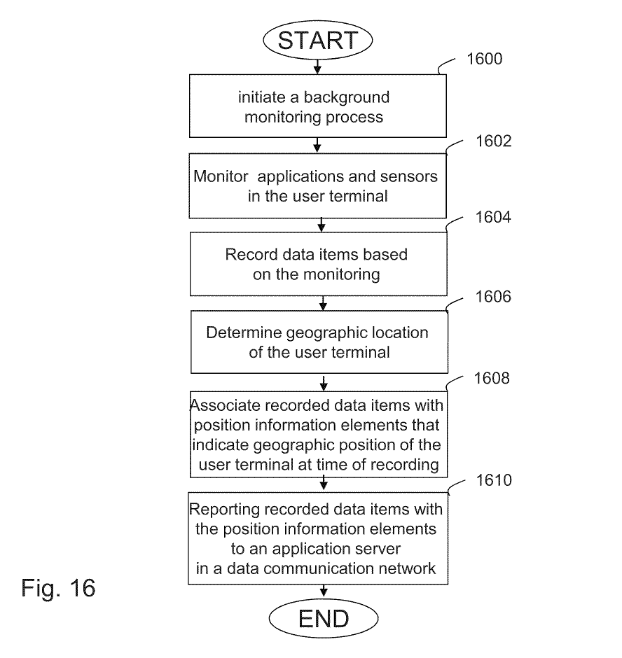

FIG. 16 shows a flow diagram illustrating an example of operation of any one of the user terminals A1501, B1502, C1503, D1504, E1505, and F1506. The background monitoring process 1502 is initiated (automatically or by the user) in step 1600, and the background monitoring process 1502 monitors application(s) and/or sensors in step 1602 in the user terminal. The background monitoring process 1502 records data items based on the monitoring in step 1604, for example in accordance with any one or combination of embodiments explained above. The background monitoring process 1502 may also determine the geographic position of the user terminal in step 1606, associate the recorded data items with position information elements that indicate geographic position of the user terminal at time of recording in step 1608, and report the recorded data items with the position information elements to an application server 1500 in a data communication network in step 1610, for example in accordance with any one or combination of embodiments explained above.

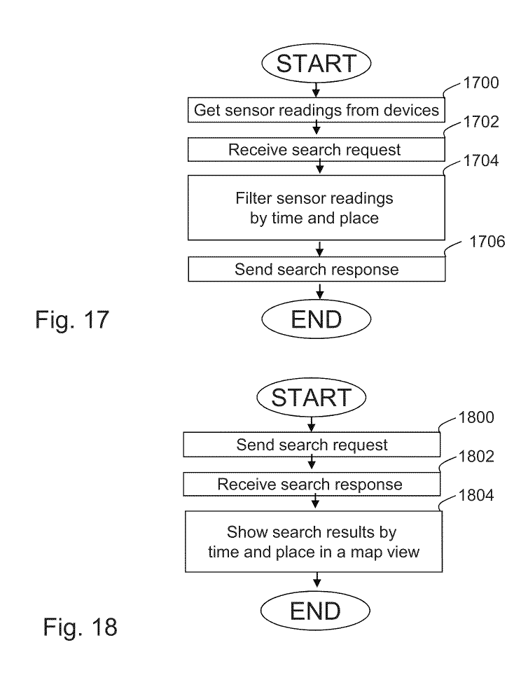

FIG. 17 shows a flow diagram illustrating an example of operation of an application server 1500. FIG. 18 shows a flow diagram illustrating an example of a search operation of a user terminal 1507. Similar type of searches may also be performed by any one of the user terminals A1501, B1502, C1503, D1504, E1505, and F1506. Referring to FIG. 17, step 1700, the application server may get data items (e.g. sensor readings) from the user terminals A1501, B1502, C1503, D1504, E1505, and F1506, and process them, for example in accordance with any one or combination of embodiments explained above. Referring to FIG. 18, step 1800, the user terminal 1507 may send a search request. The search terms may inputted by the user via the user interface. The search may be performed, for example, in accordance with any one or combination of embodiments explained above for consuming data items. In plain text, examples of searches directed to one or more user terminals within a geographic area include: “How many applications in total? How many applications are running at this very moment? Where? What altitude is the device at? How often do they run? Which is orientation of the device? How much is the device bent/strech? Which is the G force affecting on the device? Which is the angle of the device?”

Referring again to FIG. 17, the application server may receive the search request in step 1702, filter the obtained sensor readings accordingly, e.g. by time and place, in step 1704 so as to provide search results that can be displayed in a map view, and send the search response to the user terminal 1507 in step 1706. For example, search results in a search response may include: “Device A has 36 applications. Device B is at 4160 m altitude. Device C has horizontal view. Device D orientation is X-axis 45°, y-axis 96°. Device E is bent 5.6%. Device F has 1.4 G force.” Generally, the operation of the application server 1500 may be similar to an application node in any one or combination of embodiment described above.

Referring again to FIG. 18, the user terminal 1507 may receive the search response in step 1802 and show the search results in a map view in step 1804. An example of a map view of the user terminal 1507 is illustrated in FIG. 15. The user terminals A, B, C, D, E and F are located on the map view according to their geographic locations and provided with the relevant sensor readings.

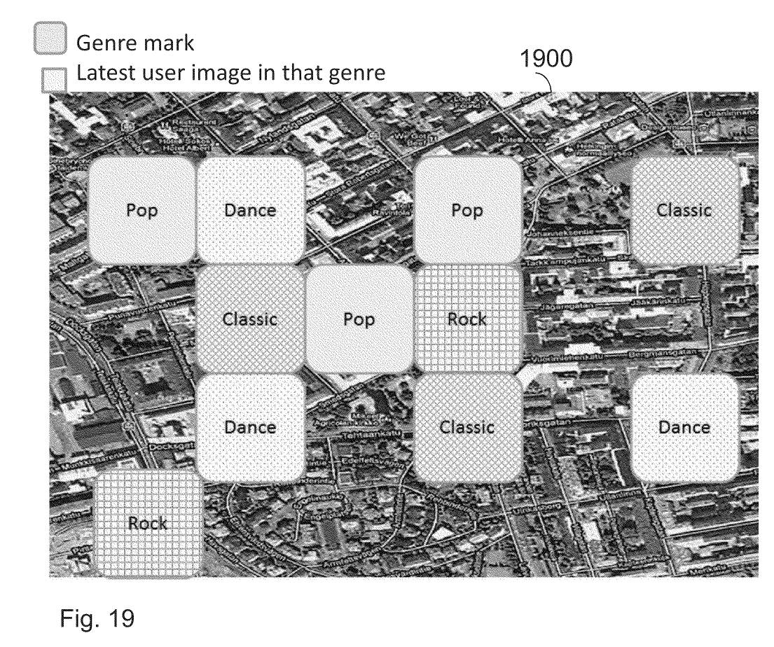

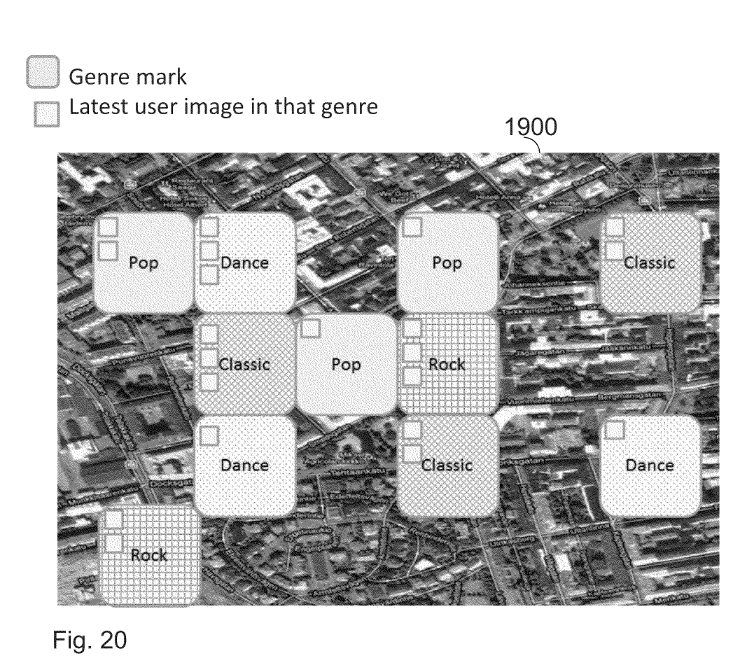

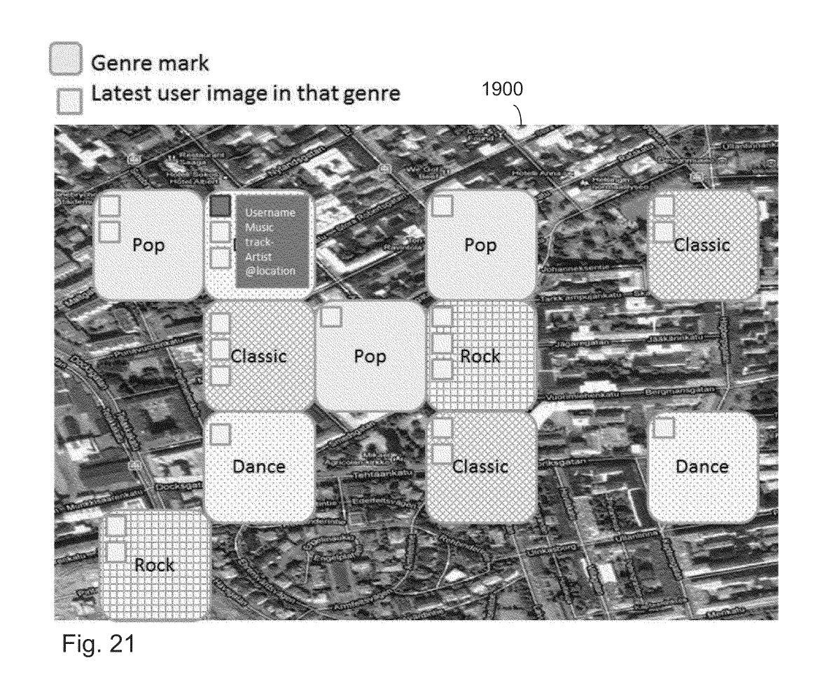

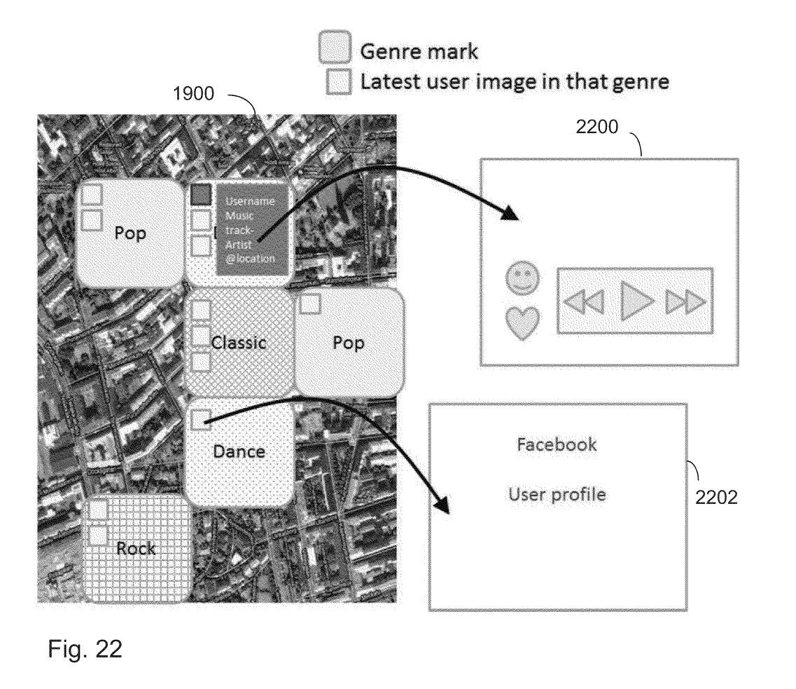

FIGS. 19, 20, 21 and 22 illustrates examples of a user interface (UI) map views which may be displayed in a consuming user terminal, when user applications in a plurality of user terminals within a specific geographic area are monitored by background monitoring application according to exemplary embodiments of the invention. In this example, the music genre played in user terminals within the geographic area is monitored. The music genres may include pop, rock, dance and classic, for example. As discussed above with reference to FIGS. 8A and 8B, a scoped map view 1900 may comprise a number of separate coordinate elements which subdivide the geographic area into a mesh of subareas. The appearance, such as the texture, the contrast or brightness or color of the coordinate elements on the map view may vary according to the proportion of interesting data items in each specific subarea based on position information elements of the indexing records of a plurality of mobile user terminals stored in the application server, each coordinate element corresponding to at least one position information element. In the example of FIG. 19-21, the map view is subdivided into rectangular subareas or coordinate-elements whose texture and colour depend of the dominating music genre consumed within each respective subarea. In FIG. 20, in addition to the genre mark in the subarea, there may also be shown more information, such as a latest user image in that genre, for example an image of a user or an artist. The user image or like may be a link, which when clicked, opens a window showing more information about the user and the music, such as a username, music track, artist, location, etc., as illustrated in the dance genre mark at top-left corner in FIG. 21. Further, clicking the music track link in FIG. 21 may open a media player 2200 which plays the respective track, as illustrated in FIG. 22. Alternatively, clicking of the user image or like may open a Facebook user profile 2202 for a respective user, or any other information associated with the specific user, as illustrated in FIG. 22. It will be obvious to a person skilled in the art that, as the technology advances, the inventive concept can be implemented in various ways. The invention and its embodiments are not limited to the examples described above but may vary within the scope of the claims.

1. A method, comprising:
initiating a background monitoring process in a mobile user terminal of a communication system;
monitoring, by said background monitoring process, application programs or at least one sensor in the mobile user terminal;
recording, by said background monitoring process, data items based on said monitoring;
determining, by said background monitoring process, a geographic location of the mobile user terminal;
associating, by said background monitoring process, said recorded data items with position information element that indicate a geographic position of the mobile user terminal at time of recording; and
reporting, by said background monitoring process, the recorded data items with said position information elements to an application server in a data communication network to be used in a search service.

2. A method according to claim 1, wherein said monitoring comprises monitoring one or more of following parameters: altitude of the mobile user terminal, atmospheric pressure affecting on the mobile user terminal, orientation of the mobile user terminal, g-force affecting on the mobile user terminal, bending of the mobile user terminal, stretching of the mobile user terminal, angle of the mobile user terminal, number of applications in the mobile user terminal, number of active applications in the mobile user terminal, frequency of use of applications in the mobile user terminal, statistics of applications in the mobile user terminal, type of media played by an application in the mobile user terminal, details of media played by an application in the mobile user terminal, statistics of media played by an application in the mobile user terminal.

3. A method according to claim 1, wherein said monitoring comprises monitoring at least one physical parameter by a sensor device.

4. A method according to claim 1, wherein said reporting comprises generating, by said background monitoring process, for data items an indexing record, an indexing record of a data item including the position information element;
sending, by said background monitoring process, the indexing record to the application node storing the indexing records of a plurality of mobile user terminals.

5. A method according to claim 4, comprising
searching data items reported by a plurality of other mobile user terminals to the application server in the data communication network, said searching further comprising
a) providing a selection view based on the indexing records stored in the application node, the position selection view comprising a number of separate coordinate elements dividing the geographic area into a mesh of subareas, the contrast or brightness or color of the coordinate elements on the map view varying according to the proportion of interesting data items in each specific subarea based on position information elements of the indexing records of said plurality of mobile user terminals stored in the application node, each coordinate element corresponding to at least one position information element.

6. A method according to claim 4, comprising
searching data items reported by a plurality of other mobile user terminals to the application server in the data communication network, said searching further comprising
a) providing, by said background monitoring process, a first selection view for selecting a number of coordinate elements;
b) providing subsequently a second selection view for selecting data items, indexing records of which include a position information element that corresponds with a coordinate element selected through the first selection view; and
c) retrieving through the telecommunication system the data items selected through the second selection view.

7. A method according to claim 1, comprising
searching data items reported by a plurality of other mobile user terminals to the application server in the data communication network, said searching further comprising
a) requesting from the application server data regarding at least one parameter monitored and reported by said background monitoring of at least one of said plurality of other mobile user terminals; and
b) displaying search results according to time and place on a display of said mobile user terminal.

8. A method according to claim 1, comprising searching data items reported by a plurality of other mobile user terminals to the application server in the data communication network, said searching further comprising
a) providing a position selection view, the position selection view comprising a number of separate coordinate elements, a coordinate element corresponding to at least one position information element;
b) providing, in response to a selection of a coordinate element from the position selection view, a data item view comprising data items associated with position information elements that correspond with the selected coordinate element; and
c) providing, in response to a selection of a data item, access to the data item.

9. A method according to claim 5, wherein the data items include data items relating to characteristics of media played in media player applications in the plurality of mobile user terminals.

10. A method according claim 9, wherein the appearance of the coordinate elements on the map view vary according to the proportion of a genre or another characteristic of the media in each specific subarea.

11. A method, comprising:
running a background monitoring process in a plurality of mobile user terminals of a communication system;
monitoring, by said background monitoring process in each of said plurality of mobile user terminals, application programs or at least one sensor in said respective mobile user terminal;
recording, by said background monitoring process in each of said plurality of mobile user terminals, data items based on said monitoring;
determining, by said background monitoring process in each of said plurality of mobile user terminals, a geographic location of said respective mobile user terminal;
associating, by said background monitoring process in each of said plurality of mobile user terminals, said recorded data items with position information element that indicate a geographic position of said respective mobile user terminal at time of recording;
reporting, by said background monitoring process in each of said plurality of mobile user terminals, the recorded data items with said position information elements to an application server in a data communication network;
providing, by said application server, a search service for searching with a search criterion among the data items reported by said plurality of mobile user terminals.

12. A method according to claim 11, wherein said monitoring comprises monitoring one or more of following parameters: altitude of the mobile user terminal, atmospheric pressure affecting on the mobile user terminal, orientation of the mobile user terminal, g-force affecting on the mobile user terminal, bending of the mobile user terminal, stretching of the mobile user terminal, angle of the mobile user terminal, number of applications in the mobile user terminal, number of active applications in the mobile user terminal, frequency of use of applications in the mobile user terminal, statistics of applications in the mobile user terminal, type of media played by an application in the mobile user terminal, details of media played by an application in the mobile user terminal, statistics of media played by an application in the mobile user terminal.

13. A mobile user terminal comprising at least one processor and at least one memory including computer program code, the at least one memory and the computer program code configured to, with the at least one processor, cause the mobile user terminal at least to perform:
monitor, as a background monitoring process, application programs or at least one sensor in the mobile user terminal;
record, as a background monitoring process, data items based on said monitoring;
determining, as a background monitoring process, a geographic location of the mobile user terminal;
associating, as a background monitoring process, said recorded data items with position information element that indicate a geographic position of the mobile user terminal at time of recording; and
reporting, as a background monitoring process, the recorded data items with said position information elements to an application server in a data communication network to be used in a search service.

14. A system comprising,
a plurality of mobile user terminals of a communication system, each mobile user terminal comprising at least one processor and at least one memory including computer program code, the at least one memory and the computer program code configured to, with the at least one processor, cause the mobile user terminal at least to perform;
a) monitor, as a background monitoring process, application programs or at least one sensor in said respective mobile user terminal;
b) record, as a background monitoring process, data items based on said monitoring;
c) determine, as a background monitoring process, a geographic location of said respective mobile user terminal;
d) associate, as a background monitoring process, said recorded data items with position information element that indicate a geographic position of said respective mobile user terminal at time of recording;
e) report, as a background monitoring process, the recorded data items with said position information elements to an application server in a data communication network;
said application server comprising at least one processor and at least one memory including computer program code, the at least one memory and the computer program code configured to, with the at least one processor, cause the application server at least to provide a search service for searching with a search criterion among the data items reported by said plurality of mobile user terminals.

15. A method comprising:
receiving at an application server in a data communication network data items reported by a plurality of mobile user terminals, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording;
providing, by said application server, a search service for searching with a search criterion among the data items reported by said plurality of mobile user terminals.

16. An application server comprising at least one processor and at least one memory including computer program code, the at least one memory and the computer program code configured to, with the at least one processor, cause the application server at least to perform:
receive data items reported by a plurality of mobile user terminals, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording;
provide a search service for searching with a search criterion among the data items reported by said plurality of mobile user terminals.

17. A method comprising
searching, by a mobile user terminal, data items reported by a plurality of other mobile user terminals to an application server in the data communication network, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording; said searching further comprising providing a selection view based on the indexing records stored in the application node, the position selection view comprising a number of separate coordinate elements dividing the geographic area into a mesh of subareas, the appearance of the coordinate elements on the map view varying according to the proportion of interesting data items in each specific subarea based on position information elements of the indexing records of said plurality of mobile user terminals stored in the application node, each coordinate element corresponding to at least one position information element.

18. A method according to claim 17, wherein the data items include data items relating to characteristics of media played in media player applications in the plurality of mobile user terminals.

19. A method according claim 18, wherein the appearance of the coordinate elements on the map view vary according to the proportion of a genre or another characteristic of the media in each specific subarea.

20. A mobile user terminal comprising at least one processor and at least one memory including computer program code, the at least one memory and the computer program code configured to, with the at least one processor, cause the mobile user terminal at least to perform:
search, by a mobile user terminal, data items reported by a plurality of other mobile user terminals to an application server in the data communication network, said reported data items being recorded based monitoring as a background monitoring process in each of said plurality of mobile user terminals application programs or at least one sensor in said respective mobile user terminal, said reported data items being associate with position information element that indicate a geographic position of said respective mobile user terminal at time of recording; said searching further comprising
provide a selection view based on the indexing records stored in the application node, the position selection view comprising a number of separate coordinate elements dividing the geographic area into a mesh of subareas, the appearance of the coordinate elements on the map view varying according to the proportion of interesting data items in each specific subarea based on position information elements of the indexing records of said plurality of mobile user terminals stored in the application node, each coordinate element corresponding to at least one position information element.
